(19) United States
(12) Patent Application Publication
(10) Pub. No.: US 2020/0398379 A1
(43) Pub. Date: Dec. 24, 2020

(54) Method For Determining Stresses And Shape Deviations In An Additively Produced Construction

(71) Applicant: Siemens Aktiengesellschaft, Muenchen (DE)

(72) Inventors: Daniel Reznik, Berlin (DE); Darya Kastsian, Falkensee (DE)

(73) Assignee: Siemens Aktiengesellschaft, Muenchen (DE)

(21) Appl. No.: 16/090,678

(22) PCT Filed: Apr. 25, 2016
(86) PCT No.: PCT/EP2016/059186

§ 371 Date: Sep. 4, 2020

(30) Foreign Application Priority Data
Apr. 6, 2016 (DE) 10 2016 205 710.3

(51) Int. Cl. B23K 26/342; B33Y 50/02; G06F 30/23

(52) U.S. Cl. CPC B23K 26/342; G06F 2111/10; G06F 30/23; B33Y 50/02

(57) ABSTRACT

The invention relates to a method for determining production-related shape deviations (ε_{l,i}) and stresses in a construction (11) produced by means of an additive production method, which construction is produced by solidifying construction material in successive layers (12). The invention further relates to a use of said method to produce corrected production data (19) and to the application of said production data in an additive production system. The invention further relates to a computer-readable data carrier and to a computer program for performing said method and to a simulation in which such a computer program can run. In the method, superlayers (13) are used in order to reduce the computational complexity of the simulation. According to the invention, in order to ensure a simulation result of sufficient accuracy with justifiable computational complexity, effective shrinkage factors (αᵢ or α_{l,i}) are determined for the solidified construction material in order to calculate the effective thermal shrinkage (εₗ or ε_{l,i}) in each superlayer (13).

### CROSS-REFERENCE TO RELATED APPLICATIONS

This application is a U.S. National Stage Application of International Application No. PCT/EP2016/059186 filed Apr. 25, 2016, which designates the United States of America, and claims priority to DE Application No. 10 2016 205 710.3 filed Apr. 6, 2016, the contents of which are hereby incorporated by reference in their entirety.

### TECHNICAL FIELD

The present disclosure relates to additive manufacturing. Various embodiments may include a method for establishing production-related form deviations and stresses in a construction produced by means of an additive manufacturing method. Additive manufacturing typically includes fusing construction material in successive layers.

### BACKGROUND

Selective laser sintering (also referred to as SLS), selective laser melting (also referred to as SLM), electron beam melting (also referred to as EBM), and laser metal deposition (also referred to as LMD) are examples of additive manufacturing. These methods are particularly suitable for processing metallic materials in the form of powders, by means of which construction components can be produced. In SLM, SLS, and EBM, the components are produced layer-by-layer in a powder bed. These methods are therefore also referred to as powder-bed-based additive manufacturing methods. In each case, a layer of the powder is produced in the powder bed, said layer subsequently being locally fused or sintered by an energy source (laser or electron beam) in those regions in which the component should be created. Thus, the component is successively produced layer-by-layer and can be removed from the powder bed after completion.

In LMD, the powder particles are directly supplied to the surface on which material deposition should take place. In LMD, the powder particles are directly fused at the impact location on the surface by a laser and, in the process, form a layer of the component to be produced.

In typical SLS methods, the powder particles are not completely fused. Rather, care is taken when choosing the sintering temperature so that the latter lies below the melting temperature of the powder particles. By contrast, the energy influx in terms of magnitude is deliberately so high in SLM, EBM, and LMD that the powder particles are completely fused.

The aforementioned additive manufacturing methods are predominantly provided for processing metals and metal alloys. Here, work is carried out in melt-metallurgic fashion, meaning that a comparatively small volume is fused by an energy beam while the remainder of the construction created in the process remains cool in comparison therewith. There is rapid cooling after fusing, within the scope of which the material solidifies again. As a result of the thermal shrinkage connected herewith, there is a strong local tension in the solidified material, with this process occurring repeatedly in the whole construction. In the process, stress and strain distributions arise in the construction, which are difficult to predict on account of their complexity. However, the stress and strain distribution in a produced construction can disturb the dimensional stability and mechanical loadability of the construction to such a great extent that the latter has to be discarded as a reject. A plurality of iterative modifications of a geometry describing the construction, in particular, and a repeated implementation of the additive method may be necessary in order to counteract a distortion of the construction.

In this respect, it is useful to simulate the component behavior during the additive manufacturing process in order to be able to predict stresses and strains in the construction and already take these into account when generating the data records describing the construction. There have already been various approaches to this end, as may be gathered from B. Schoinochoritis et al., “Simulation of metallic powder bed additive manufacturing processes with the finite element method: A critical review”, Proc IMichE part B, J. Engineering Manufacture 1-22, 2015. However, the main problem consists of an FEM having to process such a large amount of data that the required computational times would not be justifiable from an economic point of view. Therefore, simplifying assumptions must be made in the FEM calculations; these impair the accuracy of the calculated results.

An additional approach is proposed by N. Keller et al. in “New method for fast predictions of residual stress and distortion of AM parts”, Solid Freeform Fabrication, 2014, pages 1229-1237. In order to shorten the computational times, the method implements combining a plurality of layers into superlayers in place of the individual layers of the construction to be produced, the construction material behaving in similar fashion in said superlayers. Hence, fewer method steps have to be calculated, with the complexity of the simulation being reduced hereby. In order to calculate the stresses occurring in the superlayer, a coefficient of expansion present in the superlayer is assumed, said coefficient of expansion reflecting the behavior of a certain material. The increase in the computational errors accompanying the simplification of the simulation is accepted in the interest of reduced computational times.

### SUMMARY

The teachings of the present disclosure may include a method for producing corrected data that describe the geometry of the construction, wherein the data are corrected to the effect of expansions occurring as a result of a geometry deviating from the desired geometry of the construction being compensated in the data that describe the geometry. The object consists of improving a method to the effect of being connected to as little computational outlay as possible when the method is carried out, wherein the method can be used to calculate a calculation result for the stresses and form deviations occurring in the construction, said stresses and form deviations corresponding to the greatest possible extent to the stresses and form deviations occurring in actual fact when carrying out the additive manufacturing method. Furthermore, the teachings of the present disclosure may make this method accessible by use in a method for producing corrected data that describe the geometry of the construction or a method for additive production of the construction with the aforementioned properties. Lastly, the teachings of the present disclosure may be embodied in a computer-readable data medium, a computer program, or a simulator for establishing production-related form deviations and stresses in the construction, in which the aforementioned method is implemented.

As an example, some embodiments may include a method for establishing production-related form deviations and stresses in a construction (11) produced by means of an additive manufacturing method, said construction being produced by fusing construction material in successive layers (12), in which a processor (41) uses the geometry of the data describing the construction (11) in order to produce a mesh of finite elements. For example, in some embodiments, the processor (41) arranges the finite elements in such a way that these in each case lie completely in superlayers (13), the superlayers (13) in each case consisting of a plurality of layers (12) of the construction (11) to be produced, determines the cooling behavior for each superlayer (13) and calculates from the cooling behavior the stresses and form deviations in the construction (11) resulting from thermal shrinkage by way of a finite element method (FEM). In some embodiments, the processor (41) establishes solidification-related stresses and form deviations in the construction by taking account of the superlayers (13) in the order of the creation thereof. The processor (41) determines a mean temperature Tₗ of the relevant superlayer (13) from the cooling behavior of the relevant superlayer (13). The processor (41) calculates the thermal shrinkage in the relevant superlayer (13) by virtue of the processor (41) taking account of an effective shrinkage factor αᵢ or α_{l,i} for solidified construction material and calculating a relative thermal shrinkage εₗ or ε_{l,i} in the relevant superlayer (13), taking account of the melting temperature Tₛ of the construction material and without taking account of other superlayers (13), as

εₗ=αᵢ(Tₛ−Tₗ) or ε_{l,i}=α_{l,i}(Tₛ−Tₗ),
the processor (41) calculates the resultant stresses and form deviations in the relevant superlayer (13) by virtue of the processor (41) taking account of the stresses and form deviations of superlayers (13) that were already produced.

In some embodiments, the processor (41) determines the cooling behavior of the relevant superlayer (13) by virtue of the processor (41) for the cooling only taking account of already produced parts of the construction (11) being created, averaging the energy influx into the construction (11) being created over the time period of the production of the relevant superlayer (13) and uniformly distributing said energy influx over the surface area of the superlayer (13), determining a heat loss for the relevant superlayer (13) during the period of production of this superlayer (13) and determining the mean temperature Tₗ of the relevant superlayer (13) while taking account of energy influx and heat loss.

In some embodiments, the processor (41) bases a calculation of the resultant stresses and form deviations on a time-dependent continuous temperature curve Tₗ(t) in the relevant layer, said curve running from the melting temperature Tₛ to the mean temperature Tₗ.

In some embodiments, the shrinkage factor αᵢ is established by producing a sample of the employed construction material and measuring the produced sample and said shrinkage factor is made available to the processor (41).

In some embodiments, the processor (41) or a processor corresponding with this processor calculates the shrinkage factor αᵢ or α_{l,i} by calculating, using a finite element method (FEM), stresses and form deviations in a representative volume element (RVE) produced by means of the additive manufacturing method.

In some embodiments, the processor (41) or the processor corresponding with this processor assembles the representative volume element (RVE) from a multiplicity of irradiation traces (14), which lie above one another in a plurality of layers, wherein the curve of the irradiation traces (14) is set in accordance with an irradiation pattern that was planned for the additive manufacturing method.

In some embodiments, the irradiation traces (14) extend in straight lines and parallel to one another in the respective layer.

In some embodiments, the processor (41) or the processor corresponding with this processor calculates all irradiation traces (14) under the boundary conditions that said irradiation traces are slated in straight lines on already solidified construction material of an adjacent irradiation trace (14).

In some embodiments, the processor (41) or the processor corresponding with this processor calculates a temperature distribution in the irradiation traces (14) by way of a finite element method.

In some embodiments, the processor (41) or the processor corresponding with this processor determines at least one of the effective shrinkage factors α_{l,i} in such a way that the determination thereof is based on the solidification of the construction material on a substrate with a stiffness Cᵢ.

In some embodiments, the processor (41) or the processor corresponding with this processor determines for the relevant superlayer (13) an effective shrinkage factor α_{l,i}, applicable to this layer, taking account of the stiffness C_{l-1,i} of the construction lying below the relevant superlayer (13).

In some embodiments, the processor (41) or the processor corresponding with this processor uses the representative volume element (RVE) with a height corresponding to the thickness of the relevant superlayer, produces a mesh of finite elements describing the relevant superlayer, said mesh having a link to a substrate with the stiffness C_{l-1,i} of the construction (11) lying under the relevant superlayer (13), calculates by way of a finite element method (FEM) a relative tension of the construction (11) lying under the relevant superlayer (13) taking account of the decrease in temperature from the melting temperature Tₛ to the temperature of the layer Tₗ and establishes the effective shrinkage factor applicable to the relevant superlayer (13) by virtue of said processor generating a homogeneously solidified volume element (HVE) of the same material and same dimensions as the relevant representative volume element (RVE) and by virtue of said processor adapting a thermal shrinkage factor α of the homogeneously solidified volume element (HVE) in such a way that the stresses or form deviations that were calculated previously for the representative volume element (RVE) are also present at an interface between the homogeneously solidified volume element (HVE) and the construction lying under the relevant superlayer (13).

In some embodiments, the superlayers (13) in each case consist of at least 10 and at most 20 layers (12) of the construction (11) to be produced.

In some embodiments, the solidification of construction material is implemented by means of an energy beam and the processor (41) or a processor corresponding with this processor calculates the energy influx Q as a product of the power of the energy beam, the difference between 1 and the reflectivity of the construction material and the quotient of a writing time, within which the energy beam solidifies construction material, and the overall processing time of the relevant superlayer.

In some embodiments, the processor (41) or a processor corresponding with this processor calculates additional thermal shrinkage of the construction, caused by cooling to a uniform temperature level, using a finite element method (FEM) by virtue of said processor taking account of the construction (11) with the established solidification-related resultant stresses and form deviations as a whole, applying to the construction (11) a temperature profile resulting for the construction (11) after the cooling behavior of the last superlayer (13) of the construction was determined, calculating the additional stresses and form deviations when lowering the temperature to said temperature level and overlaying these on the production-related established, resultant stresses and form deviations.

In some embodiments, the processor (41) or a processor corresponding with this processor subdivides at least one of the superlayers (13) into volume segments (15), wherein the volume segments (15) together yield the volume of the superlayer, individually calculates for the relevant superlayer (13) the cooling behavior for each of the volume segments (15), and said processor calculates the thermal shrinkage in the relevant superlayer (13) by virtue of said processor individually determining for each of the volume segments (15) an effective shrinkage factor α_{l,i} for solidified construction material and individually calculating for each of the volume segments (15) a relative thermal shrinkage ε_{l,i} in the volume segment (15) taking account of the melting temperature Tₛ of the construction material and without taking account of other superlayers (13) and volume segments (15) as

ε_{l,i}=α_{l,i}(Tₛ−Tₗ),
and said processor calculates the resultant stresses and form deviations in each volume segment of the relevant superlayer (13) by virtue of the stresses and form deviations of already produced superlayers (13) being taken into account.

As another example, some embodiments include a computer-readable data medium, stored on which there is a computer program that implements the method as described above when executed on a processor (41).

As another example, some embodiments include a simulator for establishing production-related form deviations and stresses in a construction (11) produced by means of an additive manufacturing method, said construction being produced by the solidification of construction material in successive layers (12), said simulator having a processor (41), which is programmed to implement the method as described above.

### BRIEF DESCRIPTION OF THE DRAWINGS

Further details of the teachings herein are described below with reference to the drawing. The same or corresponding drawing elements are provided with the same reference signs in each case and are only explained in more detail to the extent that differences emerge between the individual figures. In the figures:

FIG. 1 shows the progress of an exemplary embodiment of the teachings herein on the basis of intermediate results of the calculation method that are presented in simplified form;

FIGS. 2 to 5 show selected method steps of an exemplary embodiment of the method incorporating teachings of the present disclosure as flowcharts; and

FIG. 6 shows an exemplary embodiment of the method incorporating teachings of the present disclosure, implemented by a plurality of corresponding processors, said method being able to be implemented in a laser melting apparatus.

### DETAILED DESCRIPTION

In some embodiments, a processor uses data describing the geometry of the construction in order to produce a mesh of finite elements. The processor arranges the finite elements in such a way that these in each case lie completely in superlayers, the superlayers in each case consisting of a plurality of layers of the construction to be produced. The cooling behavior is determined for each superlayer by means of the processor. From the cooling behavior, the processor calculates the stresses and form deviations in the construction resulting from thermal shrinkage by way of the finite element method (abbreviated as FEM below).

The teachings herein may be used for calculating constructions which are produced by additive manufacturing methods and obtained layer-by-layer by fusing or sintering (solidifying, in general), for example, laser melting, laser sintering, electron beam melting and laser cladding. Using these methods, it is possible to produce a construction, for example in a powder bed or by direct application of powder material onto the construction being produced. Here, the construction comprises both the desired component and also auxiliary structures that may be required for the production, such as, e.g., support structures that engage on the component and that are removed after the production. Additionally, the construction may consist of a plurality of components that are produced in parallel on a building platform.

To produce the component, data describing the component (CAD model) are prepared for the chosen additive manufacturing method. The data are converted into data of the component that are adapted to the manufacturing method for the purposes of creating instructions for the manufacturing apparatus such that the suitable process steps for successively producing the component can be run through in the manufacturing apparatus. To this end, the data are prepared in such a way that the geometric data for the respective layers (slices) of the component to be produced in each case are available; this is also referred to as slicing.

In some embodiments, the processor establishes solidification-related stresses and form deviations in the construction by taking account of the superlayers in the order of the creation thereof. This means that the stresses and form deviations of superlayers that have already been produced in each case can be taken into account in the superlayer currently in production. Here, the processor determines a mean temperature Tₗ of the relevant superlayer from the cooling behavior of the relevant superlayer (i.e., the superlayer currently in production in the simulation, which is always referred to as the relevant superlayer below). Moreover, the processor calculates the thermal shrinkage in the relevant superlayer by virtue of the processor taking account of an effective shrinkage factor αᵢ or α_{l,i} for solidified construction material. From this, the processor calculates a relative thermal shrinkage εₗ or ε_{l,i} in the relevant superlayer, taking account of the melting temperature Tₛ of the construction material and without taking account of other superlayers, using one of the following formulae (depending on whether αᵢ or α_{l,i} is available).

ε=αᵢ(Tₛ−Tₗ) or ε_{l,i}=α_{l,i}(Tₛ−Tₗ).

In some embodiments, the processor calculates the resultant stresses and form deviations in the relevant superlayer by virtue of the processor taking account of the stresses and form deviations of superlayers that were already produced. These influence the stresses and form deviations of the relevant layer since, on account of the mechanical coupling, it is necessary to take account of the transmission of stresses and form deviations resulting therefrom between the superlayers in order to be able to ensure a realistic simulation. In some embodiments, already produced superlayers influence the relevant superlayer and the relevant superlayer influences superlayers to be produced in future. In this way, taking account of the superlayers in the order of their production is successful. Expressed differently, the real manufacturing process is reproduced by the simulation and the computational outlay is reduced by virtue of the FEM calculations being based on the very much thicker superlayers instead of the real layers of the manufacture.

How the component is expected to deform after the production thereof can be derived from the result of the described method. If these deformations and stress states lie outside of a tolerable range, it is possible to modify the data describing the geometry of the construction and the calculation can be carried out again in accordance with the teachings herein. As a result of this, an iterative process for optimizing the geometry of the construction to be produced arises to the extent that stresses and form deviations are compensated. In some embodiments, this happens within a justifiable computational time, and so material outlay and manufacturing time in the machine for additive production can be saved in comparison with the additive production of the real construction.

When the first produced superlayer of the construction is calculated, the fact that it is situated on a build platform should moreover be taken into account. The build platform should be taken into account as a boundary condition and it substantially behaves like a previously produced superlayer. The calculation routines that can be applied to the calculation of subsequent superlayers while taking into account the already produced superlayers therefore also find use on the build platform. It may be necessary here to take account of a Young's modulus that deviates from the superlayer, the effect of which being expressed in a different stiffness of the build platform.

Since the form deviations of the construction are known as a result of carrying out the method, the data describing the geometry of the construction can be corrected in such a way that a form deviation in the structure in the opposite direction to the calculated form deviation is provided. Since the quantitative effects of a modification of the geometry of the construction are not completely predictable, a further calculation run-through can be subsequently carried out by means of the method in order to be able to assess the effect of the measure.

In some embodiments, the cooling behavior of the relevant superlayer can be determined by the processor as set forth below. The processor for the cooling only takes account of already produced parts of the construction being created. The energy influx into the construction being created is averaged over the time period of the production of the relevant superlayer and uniformly distributed over the surface area of the superlayer. This means that a uniform energy influx over the entire area of the superlayer which is equivalent to the actual energy influx is assumed. Furthermore, the processor determines a heat loss for the relevant superlayer during the period of production of this superlayer.

Heat losses occur on account of thermal conduction within the construction being produced, thermal radiation from the construction into the powder bed and into the process chamber and as a result of convection of the process gases. Lastly, the mean temperature Tₗ of the relevant superlayer is determined while taking account of energy influx and heat loss.

The thermal consideration of the already produced construction as a whole advantageously simplifies the thermal calculation of the component by means of an FEM method. This is because it was found that the thermal processes in the construction (after solidification of the construction material) occur so slowly that a simplification to a quasi-static behavior in this case has no great effects on the accuracy of the calculation result.

In some embodiments, the processor bases a calculation of the resultant stresses and form deviations on a time-dependent continuous temperature curve Tₗ(t) in the relevant layer, said curve running from the melting temperature Tₛ to the mean temperature Tₗ. Here, the temperature difference causes the shrinkage of the construction and the stresses and form deviations resulting therefrom. This model advantageously simplifies the consideration of the temporal behavior of the temperature with a sufficient approximation of the real conditions and therefore also simplifies the calculation, having as a consequence reduced calculation times. Naturally, a different cooling behavior (e.g., an exponential cooling behavior) can be assumed instead of a linear cooling behavior should this better reflect the real cooling conditions.

In some embodiments, the shrinkage factor αᵢ may be established by producing a sample of the employed construction material and measuring the produced sample, and for said shrinkage factor to be made available to the processor. As a result of this configuration of the method, it is possible to determine the shrinkage factor taking account of the real conditions (choice of material of the construction, conditions in the additive production apparatus, method parameters). Then, this shrinkage factor is assumed for the entire construction. In some embodiments, this shrinkage factor αᵢ can also be calculated by virtue of the behavior of the sample to be produced being established by computation to this end. To this end, use can be made of known FEM methods. Determining the shrinkage factor αᵢ by experiment may take account of the real conditions without precisely knowing the interaction thereof. The calculation of a sample by means of an FEM method allows a volume that is small in comparison with the construction to be slated to this end, and so the computational outlay can be kept within boundaries.

In some embodiments, the processor or a processor corresponding with this processor may calculate the shrinkage factor αᵢ (as already mentioned above) or to calculate, depending on the relevant layer, the shrinkage factor α_{l,i} by calculating, using an FEM, stresses and form deviations in a representative volume element (abbreviated RVE below) produced by means of the additive manufacturing method. Consequently, an RVE, which comprises a certain geometry, is slated in the calculation of the shrinkage factor instead of the sample. Here, the RVE can have, e.g., the same height as the relevant superlayer. If the RVE is calculated separately in an individual manner for each superlayer, it is advantageously also possible to take account of the influences of already produced superlayers on the shrinkage behavior. This advantageously improves the accuracy of the calculation result, with the additional outlay in the calculation connected therewith remaining within acceptable limits.

In some embodiments, the shrinkage factor can be calculated by the processor or a processor corresponding with this processor. In the context of this application, a processor should be understood to mean a computational unit that is suitable for carrying out the method. A computational unit comprises an electronic circuit, with the latter being able to be housed in one or more processor cores from a structural point of view. Within the meaning of the application, a corresponding processor refers to a computational unit that can carry out calculations independently of the processor mentioned first, but which can correspond with the latter for the purposes of interchanging data. Expressed differently, the method can be carried out on one or more processors. If, in the context of this application, reference is made to “said processor”, this means one of these processors, wherein the functional process of the method is ensured by a correspondence between a plurality of processors. Within the scope of carrying out the method according to the invention, it is also possible to use more than two corresponding processors, with these not being mentioned individually but all of these being referred to as corresponding processors. In this respect, the processor mentioned first is also a corresponding processor in a group with other processors.

In some embodiments, the processor or the processor corresponding with this processor may assemble the RVE from a multiplicity of irradiation traces, which lie above one another in a plurality of layers, wherein the curve of the irradiation traces is set in accordance with an irradiation pattern that was planned for the additive manufacturing method. Expressed differently, the multiplicity of irradiation traces represent a modeling of the actually planned exposure regime of the additive manufacturing method. Consequently, the RVE substantially behaves like a volume of the real component corresponding to the RVE, wherein it is possible to make a distinction here between the individual superlayers. Then, the effective shrinking factor α_{i,1} can form a basis for the entire superlayer for the purposes of calculating the stresses and strains.

If the additive manufacturing method consists of an SLM or an EBM, the material is in fact fused and solidified as a result thereof. In this case, the irradiation traces consist of welding traces, with the material solidifying again after fusing. In the case of SLS, the material is solidified by a laser beam by way of sintering without there being complete fusing of the powder particles of the construction material. However, the way the methods are carried out is comparable. Advantageously, the irradiation traces in the respective layer (which forms a part of the superlayer) can run in straight lines and parallel to one another. This is a frequently employed exposure regime and therefore a realistic assumption in most cases. Furthermore, it is possible to take account of the profile of the irradiation traces being rotated through a certain angle from layer to layer. This is also a conventional irradiation strategy, in which there is a certain amount of compensation of the stresses and strains in the component interior, and hence also in the RVE.

In some embodiments, the processor or the processor corresponding with this processor may calculate all irradiation traces under the boundary conditions that said irradiation traces are slated in straight lines on already solidified construction material of an adjacent irradiation trace. This is because, unlike the production of a real cubic sample, the assumption can be made in the RVE that the latter is situated in the interior of the construction to be produced. Here, what also applies to the irradiation traces lying at the edge of the RVE is that said irradiation traces behave like irradiation traces lying in the component interior by virtue of adjacent irradiation traces being slated outside of the RVE. Therefore, the influence of adjacent irradiation traces that do not belong to the RVE represents a realistic approach.

In some embodiments, the processor or the processor corresponding with this processor calculates a temperature distribution in the irradiation traces by way of a finite element method. This means that the cooling behavior of the weld pool, in particular, but also the cooling after solidification of the weld pool can be modeled in a realistic manner. Here, the weld pool can be modeled as, for example, a so-called Goldak heat source, wherein this method was already described by Keller et al. in the source cited at the outset.

In some embodiments, the processor or the processor corresponding with this processor determines at least one of the effective shrinkage factors α_{l,i} based at least in part on the solidification of the construction material on a substrate with a stiffness Cᵢ. The stiffness of a build platform, on which the construction is constructed, can also be taken into account. The method for taking account of the build plate proceeds in analogous fashion to the method of taking account of the superlayer lying under the relevant superlayer, with the exception that the boundary conditions are predetermined by the material and the temperature of the build plate. In some embodiments, the build plate can also be considered in the subsequent calculations of the superlayers, in particular in view of the heat capacity of said build plate, wherein, here too, the calculation methods applying to the already produced superlayers are able to be applied in analogous fashion. In the further course of the calculations, this is achieved by virtue of the processor or the processor corresponding with this processor determining for the relevant superlayer an effective shrinkage factor α_{l,i}, applicable to this layer, taking account of the stiffness C_{l-1,i} of the superlayers (which form the previously produced construction) lying below the relevant superlayer.

The stiffness of the construction in each case situated below the relevant superlayer plays such an important role because the latter prevents unimpeded shrinkage of the relevant superlayer. Instead, there is tension between the relevant superlayer and the superlayer lying therebelow or the build platform or substrate, and so some of the form deviations produced on account of the shrinkage behavior are avoided and, instead, tension is built up between the adjacent superlayers.

In some embodiments, this behavior can be determined by computation by virtue of the processor or the processor corresponding with this processor using the RVE with a height corresponding to the thickness of the relevant superlayer. To this end, the processor produces a mesh of finite elements describing the relevant superlayer, said mesh having a link to a substrate with the stiffness C_{l-1,i} of the superlayer (or, in the case of the first superlayer, with the stiffness of the build platform Cᵢ) lying under the relevant superlayer. In some embodiments, said processor calculates by way of an FEM a relative tension of the construction (or build platform) lying under the relevant superlayer taking account of the decrease in temperature from the melting temperature Tₛ to the temperature of the layer Tₗ.

For the relevant superlayer, said processor subsequently establishes the effective shrinkage factor α_{l,i} by virtue of said processor generating a homogeneously solidified volume element (referred to as HVE below) of the same material and same dimensions as the relevant RVE. Consequently, the HVE is an ersatz volume element which does not have heterogeneous construction from individual irradiation traces but has a homogeneous, idealized joint of the corresponding material. This is used to the end of said processor adapting a thermal shrinkage factor α of the HVE in such a way that the stresses or form deviations that were calculated previously for the RVE are also present at an interface between the HVE and the construction lying under the relevant superlayer and setting said shrinkage factor α equal to α_{l,i}.

In some embodiments, the calculation can be simplified by way of the assumption of the HVE. The effective shrinkage factor applies homogeneously within the HVE, it being possible to establish the stresses and strains in an advantageous manner with a further reduced computational outlay with the aid of said effective shrinkage factor.

In order to obtain the greatest possible reduction of the computational outlay, the superlayers may be as thick as possible. In order to ensure the greatest possible accuracy of the computational result, the superlayers are as thin as possible. The task here is to find a compromise so that the calculation result can be calculated with sufficient accuracy and, at the same time, within a justifiable calculation time. In some embodiments, the compromise is achieved, in particular, if the superlayers in each case consist of at least 10 and at most 20 layers of the construction to be produced.

In some embodiments, a good approximation for the energy influx is obtained if the fusing of construction material is implemented by an energy beam and the processor or a processor corresponding with this processor calculates the energy influx Q as a product of
the power of the energy beam,
the difference between 1 and the reflectivity of the construction material and
the quotient of a writing time, within which the energy beam solidifies construction material, and the overall processing time of the relevant superlayer.

Here, all essential influencing variables for the energy influx are considered in a comparatively simple manner, wherein it was found that, on account of the temporal behavior of the already produced construction, such an approximation facilitates a sufficiently accurate assessment of the temperature behavior of the construction.

Naturally, the power of the energy beam is included directly in the energy influx Q. However, the part of the power reflected by the construction material must not be taken into account, which is expressed by the difference between 1 and the reflectivity of the construction material. Lastly, the energy influx is also reduced by the irradiation pauses, during which no power of the energy beam is introduced into the construction. This can be expressed by the quotient of the writing time, during which the power of the energy beam is introduced, in comparison with the overall processing time (including the writing pauses).

In some embodiments, the processor or a processor corresponding with this processor calculates additional thermal shrinkage of the construction, caused by cooling to a uniform temperature level, using an FEM. Here, said processor takes account of the construction with the established solidification-related resultant stresses and form deviations as a whole, after the completion of the production thereof. Here, a temperature profile resulting for the construction when the cooling behavior of the last superlayer of the construction was determined is applied to the construction. At this time, residual heat is still situated in the completed construction, said residual heat leading to further shrinkage of the construction as a whole when the construction cools to a lower temperature level. FEM is used to calculate the additional stresses and form deviations when lowering the temperature to said temperature level and said additional stresses and form deviations are overlaid on the production-related established, resultant stresses and form deviations. In some embodiments, the result is an analysis directed to the subsequent use of the component. Here, the uniform temperature level can lie at room temperature or at an operating temperature that is usual for the operation of the construction.

In some embodiments, the processor or a processor corresponding with this processor subdivides at least one of the superlayers into volume segments, wherein the volume segments together yield the volume of the superlayers. Said processor individually calculates for the relevant superlayer the cooling behavior for each of the volume segments. This refinement will lead to refined results of the simulation calculation in the case of a justifiable increase in computational outlay in the cases in which the cooling behavior in the relevant superlayer is too inhomogeneous to obtain a sufficient approximation in the simulation calculation. The refinement of the method by subdividing the relevant superlayer into volume segments need not be carried out for each of the superlayers from which the construction is composed. In order to keep the computational outlay as low as possible, such a calculation can be carried out only for the critical superlayers.

In some embodiments, the volume segments in the relevant superlayer either can be provided with a constant size or, in line with demand, provision can be made of a comparatively large-volume segment in regions of the relevant superlayer in which a homogeneous behavior is present, for example in regions of the superlayer distant from the edge, while volume segments with a smaller volume are provided in regions of the superlayer close to the edge, where the influence of cooling by thermal emission from the construction plays a greater role. By way of example, the volume segments can have the same dimensions as the RVE. In a special configuration of the invention, the superlayer can also be exclusively subdivided into volume segments having the size of the RVE, wherein volume segments with a deviating geometry may also occur in the edge layer region of the construction on account of the external contour.

In some embodiments, said processor calculates the thermal shrinkage in the relevant superlayer by virtue of this processor individually determining for each of the volume segments an effective shrinkage factor α_{l,i} for solidified construction material. Said processor individually calculates for each of the volume segments a relative thermal shrinkage ε_{l,i} in the volume segment taking account of the melting temperature Tₛ of the construction material and without taking account of other superlayers and volume segments as

ε_{l,i}=α_{l,i}(Tₛ−Tₗ).

Then, said processor calculates the resultant stresses and form deviations in each volume segment of the relevant superlayers by virtue of the stresses and form deviations of already produced superlayers being taken into account. In this respect, the volume segments are treated just like the entire superlayer, which is why the individual treatment of superlayers and volume segments of a superlayer can be selected according to requirements.

In some embodiments, the method described above may be used to produce corrected data that describe the geometry of a construction, wherein the construction is producible by way of an additive manufacturing method by solidifying, in particular fusing, construction material in successive layers. Here, the established production-related form deviations and stresses are taken into account by the processor or a processor corresponding with this processor when producing the corrected data that describe the construction. Consequently, the result is a data record for producing the construction, which leads to an improved construction when carrying out the additive manufacturing method and which consequently improves the quality thereof.

In some embodiments, the above-described method may be used in a method for additive production of a construction, in which the construction is produced by solidifying construction material in successive layers, wherein the corrected data that describe the construction, listed above, are used.

In some embodiments, a computer-readable data medium stores a computer program implementing the above-described method when executed on a processor or a plurality of corresponding processors. This computer program, which is executed on a processor and, in the process, implements the above-described method. The computer program or the computer-readable data medium, on which this computer program is stored, in this case represent embodiments of the teachings herein since the features of the above-described method are implemented when the program is run.

Some embodiments include a simulator for establishing production-related form deviations and stresses in a construction produced by means of an additive manufacturing method, said construction being produced by the solidification of construction material in successive layers, wherein this simulator comprises a processor, which is programmed to implement the above-described method such that the features that are essential to the invention are implemented by the simulator.

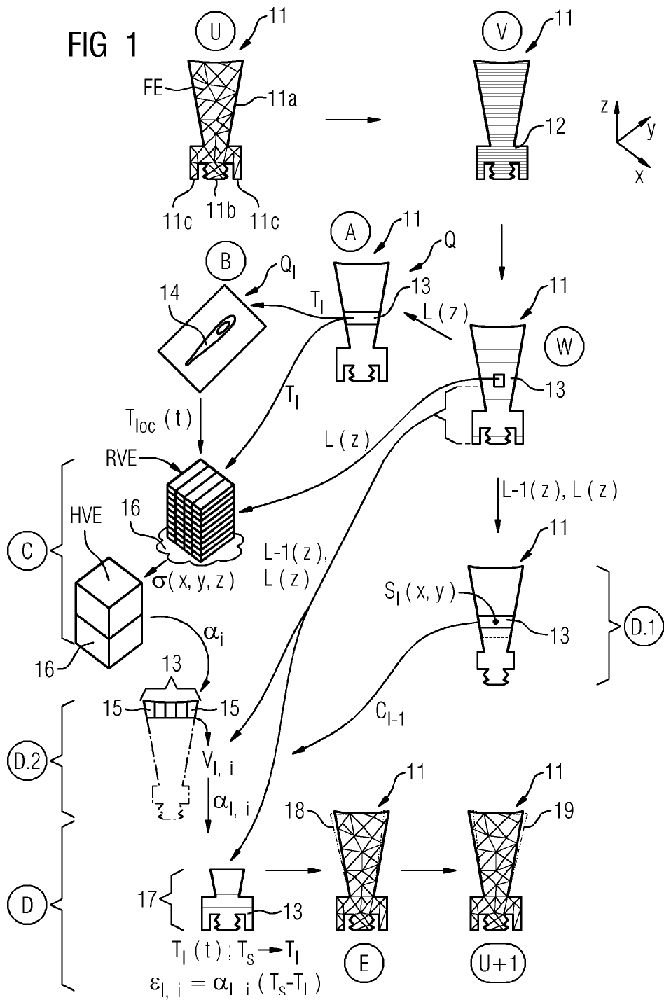

In FIG. 1, a turbine blade 11a is illustrated as a construction 11 to be produced, said turbine blade having two support structures 11c parallel to a blade root 11b for the purposes of a simplified production. The actual component consists of the turbine blade 11a with the blade root 11b, while the support structures 11c are part of the construction 11 but removed after the production.

In the manufacturing step denoted by U in FIG. 1, the construction 11 is composed as a CAD model from finite elements FE. Although this description of the component is suitable for construction purposes, it is not suitable for manufacturing the construction 11 in a laser melting method (or any other additive manufacturing method), for example. To this end, the construction 11 must be decomposed in a manner known per se by slicing in a manufacturing step V; i.e., the geometric description of the construction contains layers 12 that precisely correspond to the layers of the construction to be produced during laser melting. However, this description of the component is too fine for the purposes of applying the method according to the teachings herein, and so the computational outlay would lead to uneconomical computational times. Therefore, subdividing the construction 11 into superlayers 13, which have a greater thickness than the layers 12 to be produced, is provided in a step W for the purposes of applying the method according to the invention. In some embodiments, the superlayers may in each case exactly contain a certain number of layers, for example between 10 and 20 layers 12.

The following considerations are based on a coordinate system indicated in FIG. 1, wherein the stacking sequence of the layers or the superlayers 13 is implemented in the z-direction.

Consequently, the layers are in each case spatially aligned in the xy-plane. The superlayers 13 are indicated in step W according to FIG. 1. The greater thickness thereof in comparison with the layers 12 in step V is likewise recognizable in FIG. 1. Moreover, what is shown is that the superlayers 13 can be subdivided in turn into finite elements, wherein a subdivision into representative volume elements RVE (illustrated in method step C) is preferably implemented.

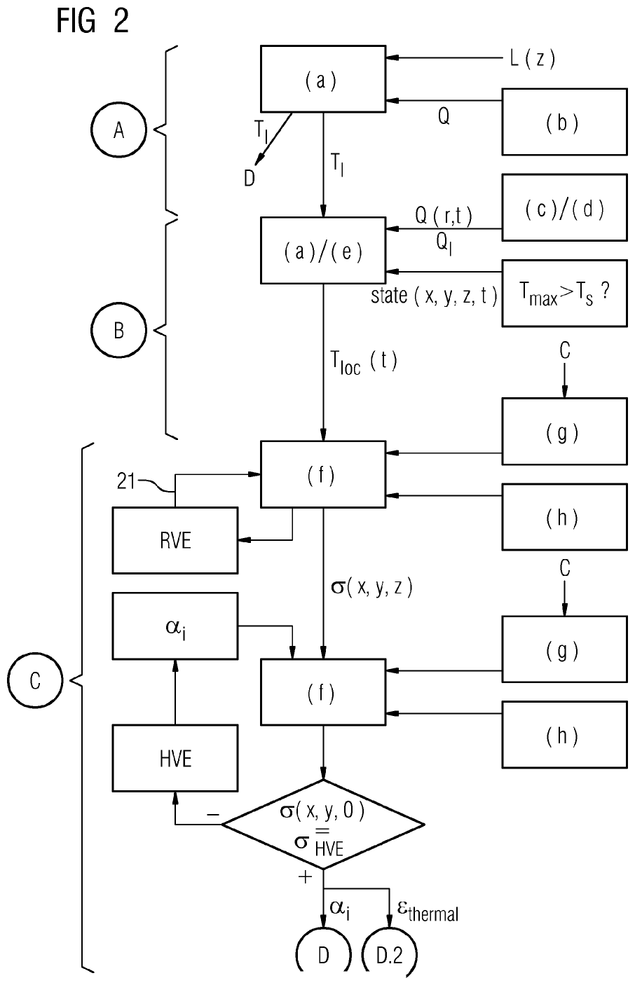

The actual calculation method is carried out by a program with four program modules A, B, C and D (optionally additionally containing D.1 and D.2 in step D). This program sequence is illustrated firstly on the basis of the model formation for the construction 11 in FIG. 1 and on the basis of program steps in FIG. 2. The four program modules facilitate a simplified consideration of the processes occurring during laser melting with sufficient accuracy and can be carried out independently of one another in the case of a suitable transfer of data, wherein a distinction can be made here according to the physical domain, the thermal and mechanical problem to be solved by the considered continuum describing the construction, and according to a macroscopic scale for the already produced construction and a mesoscopic scale for taking account of the processes in the weld pool or the freshly fused trace.

In the program module A, the thermal macroscopic scale is calculated. Here, the already produced construction 11 is considered as a whole in each case, wherein this is based on the model with the superlayers 13 to this end. From this model, it is possible to use the geometric data of the respective superlayer L(z) as input data.

The calculation of the thermal mesoscopic scale consists of a quasi-stationary solution to the thermal conduction equation

$$\frac{\partial }{\partial t} ( ρ {c}_{p} T ) - ∇ \cdot ( κ ∇ T ) = Q \qquad ( a )$$

where
ρ: density of the material
cₚ: specific heat capacity
K: thermal conductivity
as illustrated in FIG. 2 (a). Here, the assumption of a completely homogenized heating power is made, which is captured by the energy influx Q that was already explained above. Here, for the long periods of time assumed in program module A, the approximate assumption is made that the energy influx Q is distributed on average over the entire area of the superlayer 13 currently in production. The heating power is then calculated according to the relation

Q=P_{Laser}·(1−R)·(T_{Laser}/T_{work}) (b)

where
P_{Laser}: laser power
R: mean reflectivity of the material at the chosen laser wavelength
T_{Laser}: laser writing time
T_{work}: overall time for processing

T_{Laser} and T_{work} can be calculated taking account of the method progress of the laser melting. Here, the periods of time for applying the powder, during which the laser remains deactivated, are also taken into account. It is possible to consider a representative layer 12 from the superlayer 13 for the purposes of determining the ratio. It is also possible to form the ratio from considering all layers 12 in the superlayer 13.

In some embodiments, the heat losses by thermal conduction in the construction, convection in the process gas, and thermal radiation are taken into account. To this end, use can be made of usual FEM calculation models, which are generally known in the art. The calculation is carried out for a comparatively small number of constructional states of the construction. In some embodiments, the number of constructional states considered should equal the number of superlayers 13 provided in the construction. In the case of uniform constructions with a simple geometry, it may optionally also be possible to combine a plurality of superlayers if the thermal behavior of the construction in the relevant component region exhibits little change. This saves computational outlay.

As a result, a time-averaged temperature distribution in the relevant constructional states emerges from each calculation. From this, it is possible to establish a reference temperature Tₗ, which is an average temperature of the superlayer 13, in relation to which a weld pool of the laser melting must cool. To this end, the reference temperature Tₗ is transferred to the program module B. Consequently, the reference temperature Tₗ of the macroscopic scale temperature simulation established in program module A serves as a thermal boundary condition for the cooling from the weld pool. A corresponding calculation can be carried out for the weld pool, wherein this calculation can be carried out as described in Keller et al., for example. Optionally, different reference temperatures Tₗ are calculated for different superlayers 13 of the construction in program module A, and so the weld pool calculation in program step B must also be carried out for different reference temperatures Tₗ.

The temperature distribution is calculated in the mesoscopic scale, i.e. on the level of the weld pool, in program module B (see FIG. 2) and it serves to determine the temperature distribution in the weld pool. To this end, a small portion of the work piece, in which a thin layer of powder lies on an already consolidated metal layer, is considered. During the further course of the solidification of the powder, a system in which the upper layer consists partly of already consolidated metal and still partly of powder such that a metal trace is fused onto a step of consolidated material should also be calculated. The configuration described last predominantly represents the state that is present when constructing new layers 12. For the purposes of calculating these, the thermal conduction equation (a) should be solved again; however, a local energy influx Qₗ into the powder bed is chosen this time for the heating power Q. In a simplified approach, Qₗ approximately emerges as

Qₗ=P_{Laser}·(1−R) (c)

For a more accurate approach, it is also possible to assume a time-changing and spatially changing power profile of the laser, such as, e.g., a Gaussian beam profile with a width w and speed v in the x-direction and a Lambert-Beer attenuation in the material, i.e., z=0.

$$Q ( \vec{r} , t ) = {I}_{0} ( 1 - R ) exp ( - \frac{2 {( x - v t )}^{2} + 2 {y}^{2}}{{w}^{2}} ) exp ( - β z ) \qquad ( d )$$

where
Q(r,t): local energy influx
I₀: power density
β: Lambert-Beer attenuation factor of the radiation in the material
x, y, z: see the coordinate system in FIG. 1

Instead of the thermal conduction equation (a), an equivalent differential equation for the enthalpy can be solved in program module B in a preferred embodiment, said equivalent differential equation emerging as:

$$\frac{\partial }{\partial t} ( ρ H ) - ∇ \cdot ( \frac{κ}{{c}_{p}} ∇ H ) = Q \qquad ( e )$$

where:
H: enthalpy of the material

The application of this differential equation is advantageous if melting processes are calculated since the temperature around the melting point remains virtually constant in the case of a continuous enthalpy supply. Coupled with the solution to the equation (a) or (e), what also needs to be taken into account for Qₗ is the fact that the physical properties of powder and consolidated material differ greatly since the powder experiences an irreversible state change. Expressed differently, when increasing the powder temperature beyond the melting temperature, there is a conversion of powder into melt while, after cooling has taken place, the solidified material has the properties of a solid body. For the purposes of taking account of these circumstances, a phase field variable “state” is introduced, which depends on x and y (coordinates of the layer in production), z (weld pool depth) and t (temporal method progress). In the considered region of the powder bed, this corresponds in each case to the historic maximum of the temperature Tₘₐₓ (optionally also of the enthalpy). If this historic maximum lies above the melting temperature Tₛ of the powder material, then the physical properties correspond to those of the consolidated body and no longer to those of the powder. What should be taken into account here is that the heat dissipation into the consolidated body makes up a much larger absolute value than the heat dissipation into the powder, which is a poor thermal conductor. It is even possible to neglect the heat dissipation into the powder for the purposes of simplifying the approach. The solution to equation (a) or (e) taking account of the equation for the phase field variable state (x,y,z,t) yields as a result a temperature distribution in the direct vicinity of an irradiation trace 14, as illustrated in FIG. 1. Below, this is referred to as analytical fit function T_{loc}(t).

T_{loc}(t) is transmitted to program module C (see FIG. 2). In program module C, there is a mesoscopic-scale-oriented structure-mechanical simulation. To this end, the analytical fit function T_{loc}(t) is adapted to the temperature distribution for a representative irradiation trace 14, as assumed in program module B. A representative volume element, abbreviated RVE, is formed as a simulation area, said representative volume element consisting of a matrix of individual strips, as illustrated in FIG. 1.

Each strip in the RVE represents an irradiation trace for which the temperature behavior T_{loc}(t) applies. At the start of the simulation, all strips are in a powdery state. In succession, the analytical fit function T_{loc}(t) for the temperature, transferred from program module B, drives over respectively one strip, the processing of which is currently being simulated. Here, the state of the strip changes from the powdery state into the molten state when the melting temperature is reached. When the temperature in the strip lies below the melting temperature again after the passage of the melt pool, the material is present as a solid; the following system of equation is used in the calculation of the stresses and strains resulting therefrom as a consequence of thermal shrinkage, said system of equation consisting of the equation of motion (f) for a continuous medium, Hooke's law (g) and the linear thermal expansion law (h).

$$\begin{matrix}ρ \frac{{\partial }^{2} u}{\partial {t}^{2}} - ∇ \cdot σ = F & ( f ) \\ {σ}_{i j} = {C}_{i j k l} {ɛ}_{k l} \\ {ɛ}_{k l} = \frac{\partial {u}_{k}}{\partial {x}_{l}} & ( g ) \\ {ɛ}_{thermal} = {α}_{t h e r m a l} ( T - {T}_{r e f} ) & ( h )\end{matrix}$$

where:
u: 3-dimensional displacement
σ: stress tensor
F: acting force
C: stiffness tensor

The fit function T_{loc}(t) can be described as a temperature pulse that runs on the surface of the powder bed, for example in the x-direction, and pulls a cooling irradiation trace 14 behind it. As a solution to equation (f) taking account of equations (g), (h), the setting-in stress distribution after the material solidifies when the temperature pulse moves away from the considered portion arises as a solution. As indicated in the recursion loop 21 in FIG. 2, the explained calculation according to equations (f), (g), (h) for the matrix of strips of the RVE can be repeated in analogous fashion, wherein, as it were, the individual strips have successively applied to them the same, time-shifted fit function for the temperature. In the process, the resultant stress distribution in the RVE is calculated. This is a partial result of the mechanical mesoscopic-scale calculation, which is carried out in program module C (see FIG. 2).

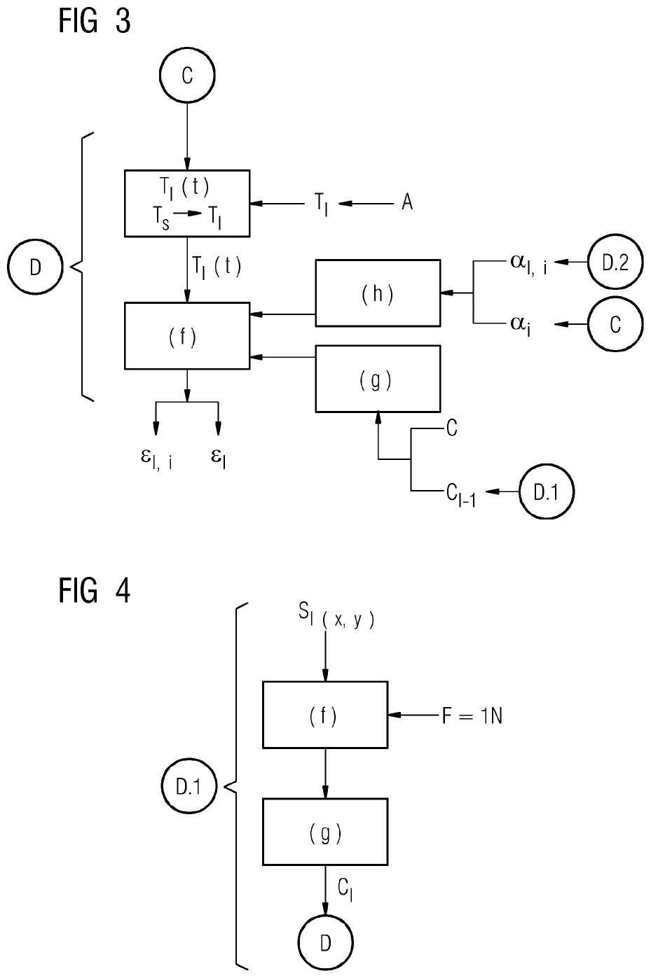

In the next step, a transfer of the mesoscopic-scale calculation to the construction must be successful. To this end, a mechanical macroscopic-scale calculation is carried out in program module C, wherein a model based on physical conditions must be formulated to this end for the stress-strain distribution in the body produced by the laser melting, represented by the construction. However, the known stress distribution σ(x, y, z), which emerges from the mesoscopic-scale calculation RVE on a stiff substrate 16 (see FIG. 1), is not suitable for this purpose. Instead, an effective shrinkage factor αᵢ(c), which is dependent on the stiffness of the substrate 16, is calculated. To this end, a material with homogeneous layer properties with the volume of the RVE is slated in place of the RVE, which preferably has the strength of the superlayer, said material with homogeneous layer properties being referred to as homogeneous volume element (abbreviated HVE) below. Now, there is a calculation in which, instead of a matrix of individual vectors in the case of the RVE, the complete volume of the HVE cools from the melt temperature Tₛ to the reference temperature Tₗ. Here, in the way already described above, equation (f) is calculated globally for the entire HVE taking account of equations (g), (h) and taking account of the stiffness C of the substrate 16. As a variation variable, a value as an effective calculation is carried out with said effective thermal shrinkage factor. In the case of correctly chosen value for αᵢ, the mean tension of the substrate 16 or of the HVE at the boundary to the substrate comprises exactly the same magnitude as the tension between the substrate and the RVE in the mesoscopic-scale calculation. In order to obtain this, a plurality of recursion loops with different αᵢ may be necessary. Once the correct effective shrinkage factor αᵢ has been found, the latter is transmitted to program module D, which is illustrated in FIG. 3.

Program module D serves for the mechanical calculation of the construction on the macroscopic-scale level, wherein a model based on physical conditions for the stress-strain distribution can be slated. The macroscopic-scale model in this case uses superlayers 13, which may have a strength from 0.5 to 1 mm, corresponding to a homogenization of 10 to 20 layers 12 to form one superlayer in each case.

The macroscopic-scale calculation assumes that the construction to be examined can be subdivided in an appropriate number of superlayers 13 in the z-direction, i.e. in the construction direction, as may be gathered from step W according to FIG. 1.

When considering the individual superlayers 13, the already constructed part 17 of the construction 11 is taken into account.

In some embodiments, in the macroscopic-scale calculation, the assumption is made that the superlayers are all present in the state of the melt at the start of the simulation. Within the scope of the simulation, a fictitious temperature is successively reduced from the melt temperature to the reference temperature tₗ established in program module A in each superlayer, from the lowermost to the uppermost, wherein a continuous function (e.g., a linear or exponential function) is assumed for the temperature curve. The thermal strain used in equation (h) is replaced by αᵢ here since the thermal problem was already solved within the scope of the mesoscopic-scale calculation and is assumed as given within the scope of the macroscopic-scale calculation.

Different stiffnesses of the substrate, the already produced construction, or the build platform in the case of the first superlayer produced, also lead to different values for the effective thermal expansion εₗ. In macroscopic bodies, the cause of the different stiffnesses lies in the geometric structure thereof. Consequently, the construction 11 being created may also have different stiffnesses C₁ at different heights z. This can be taken into account in a program module D.1, in which a calculation of the substrate stiffness C₁ is undertaken layer-by-layer. Here, an effective stiffness C₁ is assigned to each superlayer of the construction to be calculated. To this end, any known method for calculating the stiffness can be used.

By way of example, the stiffness can be estimated using the program module D.1 (see FIG. 4) as illustrated below. The method is based on the assumption that the decisive stiffness of a structure in respect of the forces caused during the thermal shrinkage of the superlayer lying thereover is given by the ratio between force and expansion, wherein the force acts in the direction of the center of gravity of the layer. To this end, the position of the center of gravity is determined for each superlayer. If the superlayer is assembled from a plurality of islands that are isolated from one another, a dedicated center of gravity is assigned to each of these islands. In the structure lying below the superlayer, i.e., in the construction already produced, each point of the interface to the current superlayer is loaded with a small test force F (e.g., 1 N) in the direction of the center of gravity S of the current superlayer (see FIG. 1). Using this, the elastic equations (f) and (g) are solved, as a consequence of which an effective stiffness C₁ can be determined for each superlayer by forming the ratio between test force F and mean displacement. This stiffness of the layer can be used to determine the effective thermal strain εₗ or ε_{l,i} in program module D with the aid of equations (f), (g), (h).

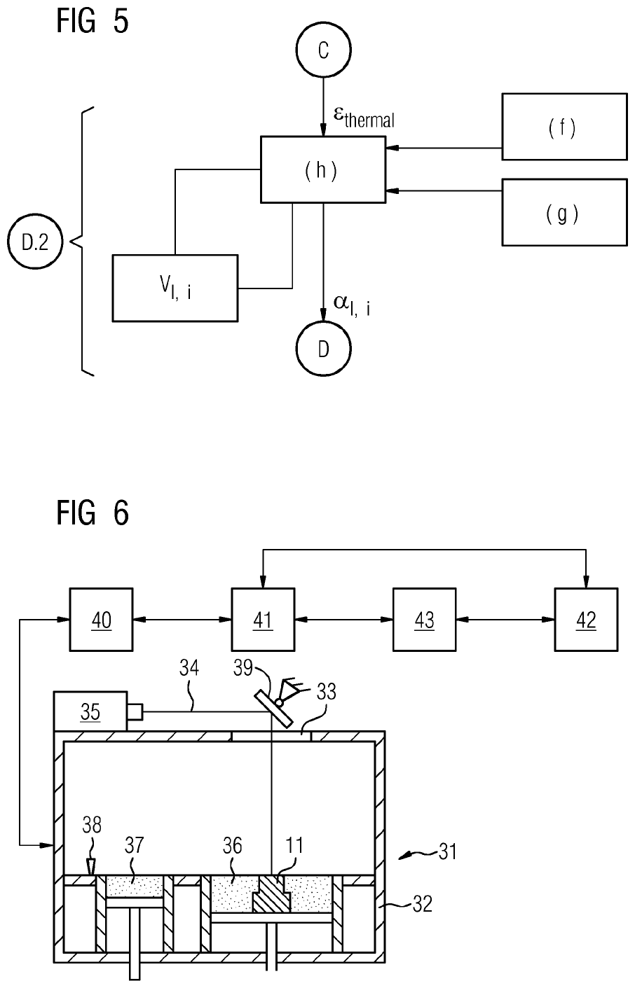

In order to further refine the model, a locally differentiated consideration of the shrinkage behavior may be implemented instead of a uniform temperature in the superlayer when calculating the effective shrinkage factor. To this end, the currently considered superlayer 13 should be subdivided into volume segments 15 in a program module D.2 (see FIG. 5) (see also L(z) from step W in step D.2 in FIG. 1). At least in the interior regions of the superlayer, these can comprise a uniform volume, in particular the volume of the RVE and HVE, but they may also comprise different sizes depending on the temperature distribution setting-in in the xy-plane. By way of example, the entire interior region can be defined as one volume segment and the entire edge region, which cools more quickly on account of thermal emissions, can be defined as a second volume segment.

The volume segments are denoted by V_{l,i}. Consequently, as indicated in FIG. 5, different effective shrinkage factors α_{l,i} should be calculated for the different volume elements V_{l,i}, it being possible to take account of said different effective shrinkage factors individually in the calculation module D (see FIG. 3).

As shown in FIG. 1, the calculated strains εᵢ or ε_{l,i} from program module D can find use in a program module E for establishing the geometry 18 of the actually produced construction that, as indicated by dashed lines, does not correspond to the original geometry of the construction 11. In a first recursion step U+1, the geometry 19 of the construction 11 to be produced can be adapted in such a way that the form deviations ε_{l,i} of a subsequent calculation step D+1 lead to the best possible extent to the desired geometry of the construction (which is illustrated in step U). This can be checked by a subsequent iteration step of the simulation.

FIG. 6 illustrates an apparatus 31 for laser melting, which comprises a process chamber 32 with a process window 33 for a laser beam 34. This laser beam 34 is produced by a laser 35, as result of which the construction 11 can be produced in a powder bed 36. The powder bed 36 is filled by way of a powder store 37, wherein a squeegee 38 is used to this end. So that the laser beam 34 can write the construction 11 in the powder bed 36, provision is moreover made of a deflection mirror 39.

The described processes may be controlled by a machine controller, wherein the latter can process the data records that were produced in the method step V according to FIG. 1. To this end, the machine controller comprises a processor 40. A further processor 41 is provided for creating the manufacturing data (slices), i.e., for producing a model of the construction 11 with layers 12. This processor 41 can obtain the data necessary to this end from a processor 42, by means of which the CAD data of the construction can be produced. Alternatively, these CAD data, as shown in steps W, A, B, C, D, D1 and D2, can be processed by a processor 43 by virtue of the above-described program modules being implemented. A calculation result for the occurring strains ε_{l,i} can be transferred from the processor 43 to the processor 42 so that, as illustrated in step E in FIG. 1, it is possible to undertake a modification of the geometry. The modified component can then be calculated by the processor 41 in order, subsequently, to undertake firstly a subdivision into superlayers 13 by means of the processor 43 and secondly a production in the laser melting apparatus 31 by way of the machine controller 40.

The configuration of the processors 40, 41, 42, 43 is only illustrated in an exemplary manner here. Additionally, functionalities can be distributed among more processors than illustrated in FIG. 6 or be combined in fewer processors. The primary object of the processor 43 is to carry out the simulation method according to the invention, although it can be assisted by corresponding processors, wherein, according to FIG. 6, these are the processors 41 and 42. Within this meaning, the processor 43 should also be understood to be a corresponding processor.

What is claimed is:

1-21. (canceled)

22. A method for additive manufacturing of an object, the method comprising:
producing a mesh of finite elements describing the object;
grouping the finite elements to define superlayers, each superlayer including a plurality of layers;
determining a respective cooling behavior for each superlayer; and
constructing an object by fusing construction material in the plurality of layers;
calculating stresses and form deviations in the object by taking account of the superlayers in the order of the creation thereof;
determining a mean temperature Tₗ of a particular superlayer from the respective cooling behavior of the particular superlayer;
calculating thermal shrinkage in the particular superlayer by taking account of an effective shrinkage factor αᵢ or α_{l,i} for solidified construction material; and
calculating a relative thermal shrinkage εₗ or ε_{l,i} in the particular superlayer by taking account of the melting temperature Tₛ of the construction material and without taking account of other superlayers, as
εₗ=αᵢ(Tₛ−Tₗ) or ε_{l,i}=α_{l,i}(Tₛ−Tₗ);
calculating the resultant stresses and form deviations in the particular superlayer by taking account of the stresses and form deviations of superlayers that were already produced; and
calculating the shrinkage factor αᵢ or α_{l,i} by calculating, using a finite element method, including stresses and form deviations in a representative volume element produced by the additive manufacturing method.

23. The method as claimed in claim 22, wherein determining the cooling behavior of the relevant superlayer includes:
averaging an energy influx into the object over a time period of the production of the relevant superlayer;
uniformly distributing said energy influx over the surface area of the superlayer;
determining a heat loss for the relevant superlayer during the period of production of this superlayer; and
determining the mean temperature Tₗ of the relevant superlayer by taking account of energy influx and heat loss.

24. The method as claimed in claim 22, wherein calculation of the resultant stresses and form deviations includes generating a time-dependent continuous temperature curve Tₗ(t) in the particular layer, the curve running from the melting temperature Tₛ to the mean temperature Tₗ.

25. The method as claimed in claim 22, further comprising assembling a representative volume element (RVE) from a multiplicity of irradiation traces lying above one another in a plurality of layers;
wherein a curve of the irradiation traces is set in accordance with an irradiation pattern planned for the additive manufacturing method.

26. The method as claimed in claim 25, wherein the irradiation traces extend in straight lines parallel to one another in the particular layer.

27. The method as claimed in claim 26, further comprising calculating all irradiation traces under boundary conditions wherein said irradiation traces are slated in straight lines on already solidified construction material of an adjacent irradiation trace.

28. The method as claimed in claim 25, further comprising calculating a temperature distribution in the irradiation traces using a finite element method.

29. The method as claimed in claim 22, further comprising determining at least one of the effective shrinkage factors α_{l,i} based on solidification of the construction material on a substrate with a stiffness Cᵢ.

30. The method as claimed in claim 29, further comprising determining for the particular superlayer an effective shrinkage factor α_{l,i}, applicable to the particular superlayer based on the stiffness C_{l-1,i} of the construction lying below the particular superlayer.

31. The method as claimed in claim 30, further comprising:
using the representative volume element (RVE) with a height corresponding to the thickness of the particular superlayer;
producing a mesh of finite elements describing the particular superlayer, the mesh having a link to a substrate with the stiffness C_{l-1,i} of the object lying under the particular superlayer;
using a finite element method to calculate a relative tension of the object lying under the particular superlayer based on a decrease in temperature from the melting temperature Tₛ to the temperature of the layer Tₗ; and
establishing the effective shrinkage factor α_{l,i} applicable to the particular superlayer by generating a homogeneously solidified volume element (HVE) of the same material and same dimensions as the relevant representative volume element (RVE); and
adapting a thermal shrinkage factor α of the homogeneously solidified volume element (HVE) so the stresses or form deviations calculated previously for the representative volume element (RVE) are also present at an interface between the homogeneously solidified volume element (HVE) and the object lying under the relevant superlayer.

32. The method as claimed in claim 22, wherein the superlayers each comprise at least 10 and at most 20 layers of the object.

33. The method as claimed in claim 22, further comprising:
solidifying construction material using an energy beam; and
calculating an energy influx Q as a product of:
a power of the energy beam,
a difference between 1 and the reflectivity of the construction material and the quotient of a writing time within which the energy beam solidifies construction material, and
an overall processing time of the particular superlayer.

34. The method as claimed in claim 1, further comprising:
calculating additional thermal shrinkage of the object caused by cooling to a uniform temperature level using a finite element method (FEM) by taking account of the object with the established solidification-related resultant stresses and form deviations as a whole;
applying to the object a temperature profile resulting after the cooling behavior of the last superlayer of the object was determined;
calculating additional stresses and form deviations when lowering the temperature to said temperature level; and
overlaying the additional stresses and form deviations on the production-related established, resultant stresses and form deviations.

35. The method as claimed in claim 22, further comprising:
subdividing at least one of the superlayers into volume segments, wherein the volume segments sum to the volume of the superlayer;
individually calculating a respective cooling behavior for each of the volume segments;
calculating thermal shrinkage in the particular superlayer by:
individually determining for each of the volume segments an effective shrinkage factor α_{l,i} for solidified construction material, and
individually calculating for each of the volume segments a relative thermal shrinkage ε_{l,i} in the volume segment based on the melting temperature Tₛ of the construction material and without taking account of other superlayers and volume segments as
ε_{l,i}=α_{l,i}(Tₛ−Tₗ); and
calculating resultant stresses and form deviations in each volume segment of the particular superlayer including accounting for the stresses and form deviations of already produced superlayers.

36. A computer-readable data medium storing a computer program, the computer program, when loaded and executed by a processor, causing the processor to perform a method for additive manufacturing of an object, the method comprising:
producing a mesh of finite elements describing the object;
grouping the finite elements to define superlayers, each superlayer including a plurality of layers;
determining a respective cooling behavior for each superlayer; and
constructing an object by fusing construction material in the plurality of layers;
calculating stresses and form deviations in the object by taking account of the superlayers in the order of the creation thereof;
determining a mean temperature Tₗ of a particular superlayer from the respective cooling behavior of the particular superlayer;
calculating thermal shrinkage in the particular superlayer by taking account of an effective shrinkage factor αᵢ or α_{l,i} for solidified construction material; and
calculating a relative thermal shrinkage εₗ or ε_{l,i} in the particular superlayer by taking account of the melting temperature Tₛ of the construction material and without taking account of other superlayers, as
εₗ=αᵢ(Tₛ−Tₗ) or ε_{l,i}=α_{l,i}(Tₛ−Tₗ);
calculating the resultant stresses and form deviations in the particular superlayer by taking account of the stresses and form deviations of superlayers that were already produced; and
calculating the shrinkage factor αᵢ or α_{l,i} by calculating, using a finite element method, including stresses and form deviations in a representative volume element produced by the additive manufacturing method.
